(19) United States
(12) Patent Application Publication
(10) Pub. No.: US 2011/0191082 A1
(43) Pub. Date: Aug. 4, 2011

(54) INTERACTIVE PLANNING TOOL AND SIMULATION SYSTEM FOR CRYOABLATION SURGERY

(75) Inventors: Daniel J. Blezek, Rochester, MN (US); Matthew R. Callstrom, Rochester, MN (US); Bradley J. Erickson, Rochester, MN (US); William J. Ryan, Rochester, MN (US)

(73) Assignee: MAYO FOUNDATION FOR MEDICAL EDUCATION AND RESEARCH, Rochester, MN (US)

(21) Appl. No.: 12/999,671

(22) PCT Filed: Jun. 19, 2009
(86) PCT No.: PCT/US09/48011

§ 371 Date: Apr. 19, 2011

Related U.S. Application Data
(60) Provisional application No. 61/132,671, filed on Jun. 20, 2008.

(51) Int. Cl. G06G 7/60

(52) U.S. Cl. 703/11

(57) ABSTRACT

A cryoablation procedure at a surgery site is planned and simulated. One or more pre-procedure planning images of the surgery site are displayed on a user interface. Positioning of one or more virtual cryoprobes relative to the one or more pre-procedure planning images on the user interface is facilitated. Properties of the one or more virtual cryoprobes are selectable. Ice ball formation at the surgery site is then simulated based on the position and properties of the virtual cryoprobes. The simulated ice ball formation is based at least in part on tissue properties of the surgery site at each image unit of the one or more pre-procedure planning images. Boundaries of the simulated ice ball formation on the one or more pre-procedure planning images are then displayed.

### CROSS-REFERENCE TO RELATED APPLICATION

The present application claims the benefit of U.S. Provisional Application No. 61/132,671 filed Jun. 20, 2008, entitled “Interactive Planning Tool And Simulation System For Cryoablation Surgery,” which is incorporated herein by reference in its entirety.

### TECHNICAL FIELD

The present invention relates to surgical planning and simulation. More particularly, the present invention relates to an interactive planning tool and simulation system for cryoablation surgery.

### BACKGROUND

Minimally-invasive methods of lesion ablation, utilizing image guidance, have become increasingly popular in recent years. One application of such image guided therapy is the destruction of neoplastic lesions through freezing, called cryoablation, which may be used for tumors in patients where open surgery is not a viable option.

In cryoablation, suitable lesions are accurately localized through radiological imaging techniques. One or more thin probes (cryoprobes) are introduced into the body via a small skin puncture, and positioned within the lesions under real-time imaging guidance. Recent advances in cryoprobe technology have provided unprecedented flexibility to the clinician. These advances include insulated probes allowing percutaneous approaches, and elimination of cryogens allowing fine control over the heat flux in the tissue. Once the probes are confirmed to be in a good position, rapid cooling is achieved through expansion of argon gas near the probe tip, progressively freezing the adjacent tissue and forming an “ice ball.” The target temperature to ensure cell death is in the range of −20° C. to −40° C., which is achieved in a region known as “lethal ice,” where cell death occurs by membrane rupture (from ice formation and changes in cellular volume) and loss of blood supply.

Imaging plays a large role in the planning, intra-procedural monitoring, and subsequent follow-up in cryoablation cases. Pre-treatment planning consists of accurate localization of lesions and careful selection of probe trajectory to maximize tumor destruction and minimize injury to normal tissue. The interventional radiologist performing the procedure has to take various factors into account, such as location of the lesion relative to critical structures, heat conducting properties of surrounding structures, amount of blood perfusions that might carry heat away from the region, and lesion shape. During the procedure, ice ball growth is monitored through serial imaging studies, allowing the operator to titrate the gas flow, and hence the freezing rate, of the probes.

### SUMMARY

The present invention relates to a system and method for planning and simulating a cryoablation procedure at a surgery site. One or more pre-procedure planning images of the surgery site are displayed on a user interface. Positioning of one or more virtual cryoprobes relative to the one or more pre-procedure planning images on the user interface is facilitated. Properties of the one or more virtual cryoprobes are selectable. Ice ball formation at the surgery site is then simulated based on the position and properties of the virtual cryoprobes. The simulated ice ball formation is based at least in part on tissue properties of the surgery site at each image unit of the one or more pre-procedure planning images. Boundaries of the simulated ice ball formation on the one or more pre-procedure planning images are then displayed.

In another aspect, the present invention relates to a method for facilitating a cryoablation procedure at a surgery site. Images of the surgery site are acquired, and one or more two-dimensional pre-procedure planning images of the surgery site based on the acquired images are displayed. Positioning of one or more virtual cryoprobes relative to the one or more pre-procedure planning images is facilitated. The virtual cryoprobes are positionable at an oblique angle relative to the one or more two-dimensional images. Ice ball formation at the surgery site is then simulated based on the position and properties of the one or more virtual cryoprobes, and boundaries of the simulated ice ball formation on the one or more pre-procedure planning images are displayed.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of a cryoablation planning and simulation system according to an embodiment of the present invention.

FIG. 2 is a view of a portion of a user interface for planning a cryoablation procedure showing virtual cryoprobes in a parallel arrangement.

FIG. 3 is a view of a portion of a user interface for planning a cryoablation procedure showing virtual cryoprobes in a crossing arrangement.

FIG. 4 is a partial screen shot of a pre-procedure planning image including boundaries of a simulated ice ball formation.

FIG. 5 is a partial screen shot of an intra-procedure image after a portion of a cryoablation procedure is performed.

FIG. 6 is a partial screen shot of a portion of the intra-procedure image shown in FIG. 5 including boundaries of an actual ice ball formation.

FIG. 7 is a partial screen shot of a portion of the intra-procedure image shown in FIG. 5 including boundaries of both the simulated and actual ice ball formation.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

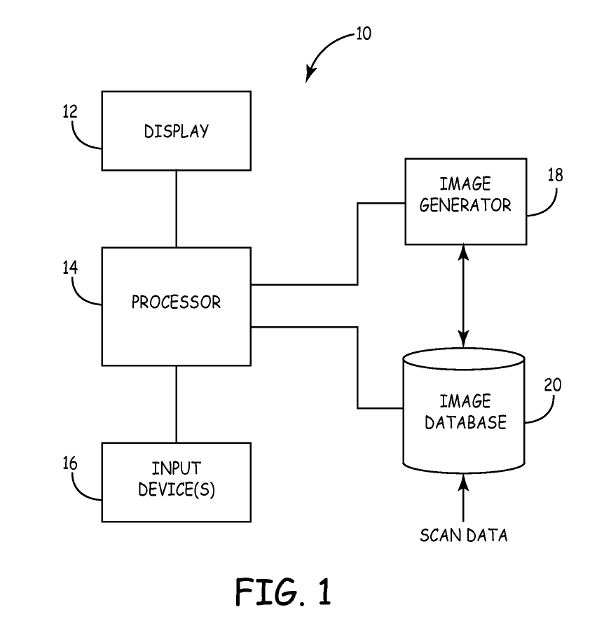

FIG. 1 is a block diagram of a cryoablation planning and simulation system 10 according to an embodiment of the present invention. System 10 includes a display 12, a processor 14, one or more input devices 16, an image generator 18, and an image database 20. The processor 14 receives inputs from the one or more input devices 16 and provides an output to the display 12. The display 12, the processor 14, and the one or more input devices 16 may be configured as a computer workstation, and the one or more input devices 16 may include, for example, a mouse, keyboard, or digital interactive pen. The processor 14 communicates with and controls both the image generator 18 and the image database 20. In some embodiments, the imaging generator 18 and the image database 20 are located locally with the processor 14. In other embodiments, the processor 14 communicates with and controls the image generator 18 and the image database 20 via a remote connection.

The image database 20 receives and stores raw data from one or more scans (e.g., CT or MR scan) of a patient. The data from the one or more scans may be used by the image generator 18 to assemble the scans into a three dimensional (3D) image of the anatomical feature on which the cryoablation procedure is to be performed. The image generator 18 may also isolate an anatomical feature of interest from the surrounding anatomy based on the response of each portion of the anatomy to the scan. For example, the anatomical feature of interest may have a different density (i.e., a different level of transparency to the scan signal) than the surrounding anatomy, and the different portions of the anatomy can thus be separated by the image generator 18 from each other based on this varying level of density. The image generator 18 may then store data related to the assembled 3D medical image in the image database 20.

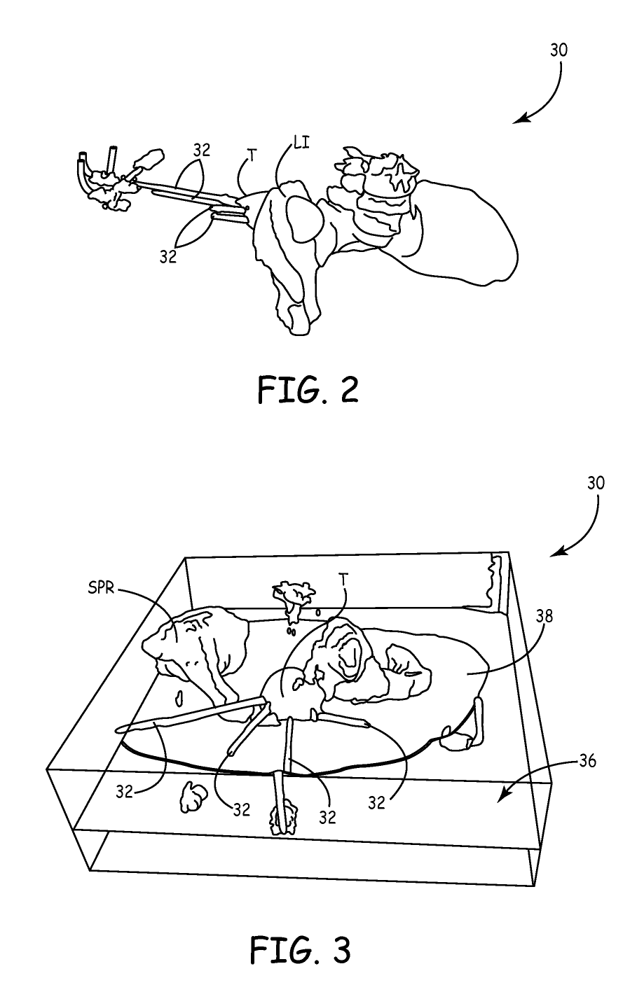

FIG. 2 is a partial screen shot of a user interface 30 for use with the cryoablation planning and simulation system 10. The user interface 30 is provided on the display 12 in the system 10 to allow a user to interact with one or more scans of a patient to develop a cryosurgery plan for subsequent simulation and analysis. The user may interact with the user interface 30 using any of the one or more input devices 16 connected to the system 10. In the embodiment shown in FIG. 2, the region around the left iliac bone LI is displayed on the user interface 30.

Several components are involved in the planning of a cryoablation procedure. Planning includes lesion visualization and selection of the trajectory of cryoablation probes to maximize destruction of the tissue to be ablated and to minimize injury to normal tissue. The number of probes, probe size, heat flux, and probe placement are some of the factors that combine to produce an ice ball of a particular shape. A clinician determines the desired shape of the ice ball during review of pre-procedure planning images, such as the image of the left iliac bone LI shown on user interface 30.

The user interface 30 allows the clinician to place virtual cryoprobes 32 relative to the tissue to be ablated for later simulation to determine whether the arrangement of virtual cryoprobes 32 provides the desired ice ball formation. In FIG. 2, four cryoprobes 32 are arranged in parallel in a tumor T in the left iliac bone LI. The clinician considers many factors when using the user interface 30 to formulate a cryosurgery plan, including the location of the lesion relative to critical structures, heat conducting properties of surrounding structures, amount of blood perfusion that may carry heat away from the region, and the lesion shape. To assist in the placement of the virtual cryoprobes 32, the user interface 30 may highlight the tumor T with a different shading or color. While four cryoprobes 32 are shown in FIG. 2, the user interface 30 allows any number of virtual cryoprobes 32 to be placed relative to the tumor T.

One aspect of the user interface 30 is the ability to view and place virtual cryoprobes 32 relative to two-dimensional slices of a three-dimensional image. The two-dimensional slices may be taken at any angle relative to any axis of the three-dimensional image. FIG. 3 is a partial screen shot of the user interface 30, showing a three-dimensional image of a right superic pubic ramus SPR including a tumor T. The right superic pubic ramus SPR is sliced with a plane 36. The plane 36 may be moved to any location through the three-dimensional image and oriented at any angle relative to the three-dimensional image. When the right superic pubic ramus SPR is sliced with the plane 36, the user interface 30 displays the tissue 38 that surrounds the tumor T in the plane 36. This allows the clinician to see the tissue adjacent to the tumor T to assist in appropriately locating the virtual cryoprobes 32 relative to normal tissue and critical structures. In some embodiments, the user interface 30 can be switched to a view that displays only the selected two-dimensional slice.

In the embodiment shown in FIG. 3, four virtual cryoprobes 32 are arranged in a crossing configuration in the tumor T. Another aspect of user interface 30 is the ability to position the virtual cryoprobes 32 at an oblique angle relative to the plane 36. The virtual cryoprobes 32 may be placed relative to the tumor T at any angle from any direction. When virtual cryoprobes 32 are so positioned, the user interface 30 adapts the location of the virtual cryoprobes 32 to adjacent slices of the three-dimensional image. In this way, the virtual cryoprobes 32 can be precisely positioned relative to the selected two-dimensional slice, while the user interface 30 translates the location of the rest of the virtual cryoprobes 32 to the surrounding tissue.

When the virtual cryoprobes 32 have been positioned as desired relative to the tumor T, properties of each of the virtual cryoprobes 32 may be set to provide an accurate response during the simulation. The properties of the virtual cryoprobes 32 that may be modified using the user interface 30 include, but are not limited to, the size, geometry, heat distribution, and heat flux (including the timing, duration, and/or magnitude) of the virtual cryoprobes 32. The properties may be varied throughout the procedure, and thus the user interface 30 allows the user to modify any parameters to simulate particular responses at different points during the procedure. For example, the properties of the virtual cryoprobes 32 may be controlled during the simulation to simulate a freeze-thaw-freeze cycle. The duration and temperature of the probes in each of these cycle segments is controllable through the user interface 30. Alternatively, the properties of the virtual cryoprobes 32 may be automatically set using a segmentation algorithm to identify regions in the images and automatically assign them appropriate heat properties.

When the virtual cryoprobes 32 have been arranged and configured, the user interface 30 (operating as a “thin client”) provides the plan to the processor 14 to simulate the response of the tissue to the cryoablation plan. Simulation results may be made available to the clinician during the simulation at specified intervals (e.g., every minute of simulation time). Particularly, the progression of the simulated ice ball formation may be provided on the user interface 30 as simulation results are generated. The clinician may interrupt the simulation at any time when satisfied with the simulated ice ball formation, or to reposition the virtual cryoprobes 32 and restart the simulation. This latter features provides the clinician quick feedback to iteratively position and configure the virtual cryoprobes 32 to produce the desired ice ball response.

Based on the plan configured with the user interface 30, the processor 14 solves heat transfer equations to simulate the response of the tumor T and surrounding tissue 38 to the virtual cryoprobes 32. The simulation determines tissue properties for each voxel in the three-dimensional image shown in the user interface 30 (or each pixel in a two-dimensional image) and boundary conditions for a partial differential equation system. The simulation incorporates models of physical properties of the virtual cryoprobes 32, as well as intrinsic tissue properties such as thermal conductivity, specific heat, blood perfusion, and so on. Using the properties of the virtual cryoprobes 32 and the tissue properties as inputs, the bioheat model computes the temperature gradient (e.g., formation of lethal ice) and time course of temperature change that will be produced by the selected cryoprobe configuration. Table 1 describes the variables that are included in the heat transfer equations.

TABLE 1
Heat Transfer Equation Variables and Units

| Variable | Description | Units |
|---|---|---|
| C | specific heat | M J m⁻³ K⁻¹ |
| T | temperature | K |
| k | thermal conductivity | W m⁻³ K⁻¹ |
| \dot{w}_{b} | blood perfusion | unitless |
| C_{b} | specific heat of blood | M J m⁻³ K⁻¹ |
| T_{b} | blood temperature | K |
| \dot{q}ₘₑₜ | metabolic heat generation | K |
| β | relaxation parameter | unitless |
| W | w_{b}C_{b}/C | unitless |
| N(Tₜ) | neighborhood of Tₜ | |
| Δxᵢ² | square distance from Tₜ to Tₜⁱ | mm |
| \tilde{C}(T) | effective specific heat | M J m⁻³ K⁻¹ |
| \tilde{k}(T) | effective thermal conductivity | W m⁻³ K⁻¹ |
| \tilde{q}ₘₑₜ(T) | effective metabolic heat | K |
| \tilde{w}_{b}(T) | effective blood perfusion | unitless |

The simulation model incorporates liquid-solid phase transition factors, in which the different thermal properties of the tissue as it moves from “fresh” to “mush” to “frozen” is taken into consideration. The last four variables in Table 1 are temperature dependent variables that model this phase change for each class of tissue.

The heat transfer equation is given below in Equation 1. The time rate of change in temperature is governed by the divergence of the temperature gradient (Laplacian for scalar fields), blood perfusion, and metabolic heat generation. Using finite differences as given in Equation 2 below with a relaxation parameter β, Equation 1 can be iteratively solved as shown in Equation 3 below. In some embodiments, the solution domain is divided into isotropic 1 mm³ elements, resulting in a time step (Δt) of 0.3 s, or 180 iterations per minute of simulated freezing.

$$\begin{matrix}C \frac{\partial T}{\partial t} = ∇ \cdot ( k ∇ T ) + {\dot{w}}_{b} {C}_{b} ( {T}_{b} - T ) + {\dot{q}}_{met} & ( 1 ) \\ {T}_{t} = β {T}_{t + Δ t} + ( 1 - β ) {T}_{t} & ( 2 ) \\ {T}_{t + Δ t} = \frac{1}{1 - W βΔ t} ( 1 - W ( 1 - β ) Δ {tT}_{t} + \frac{{\dot{q}}_{met} + {\dot{w}}_{b} {C}_{b} {T}_{b} Δ t}{C} + {\sum }_{{T}_{t}^{i} ∈ N ( {T}_{t} )} \frac{k Δ t ( {T}_{t}^{i} - {T}_{t} )}{C Δ {x}_{i}^{2}} & ( 3 )\end{matrix}$$

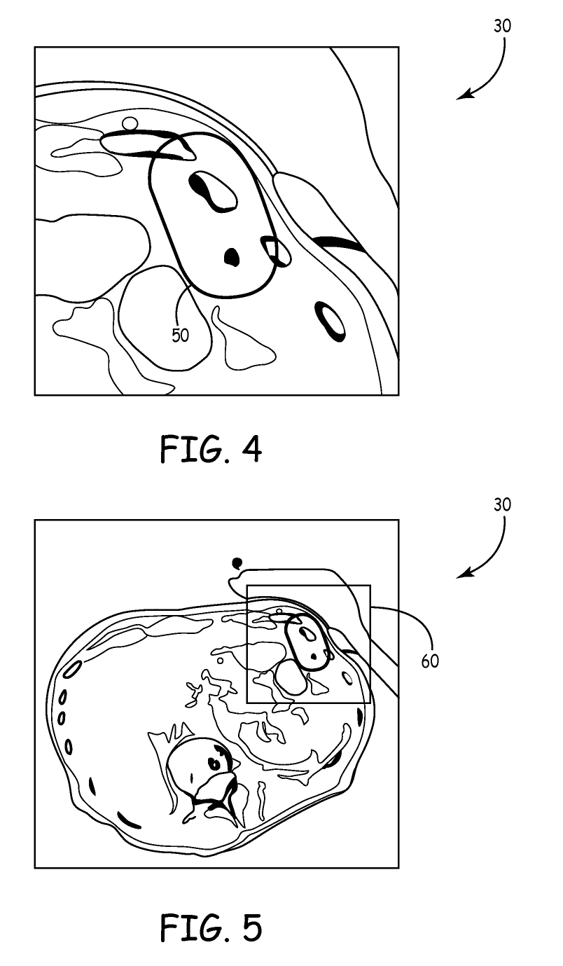

As discussed above, the boundaries of the simulated ice ball formation may be drawn on two- or three-dimensional images on the user interface 30 as the simulation progresses and/or after the simulation is completed. FIG. 4 is a partial screen shot of a two-dimensional pre-procedure planning image including boundaries 50 of a simulated ice ball formation. The boundaries 50 define the region of tissue that is affected by the cryoablation procedure. The user interface 30 can periodically display the formation of lethal ice as the simulation is run to illustrate the progression of the ice ball formation over time. This allows the clinician to pause or cancel the simulation if the progression of the ice ball formation is satisfactory, or if the ice ball formation indicates that the virtual cryoprobes 32 should be repositioned to improve the shape of the ice ball. In the latter case, the clinician can then re-simulate the procedure to determine of the repositioned virtual cryoprobes 32 provide more satisfactory results. This interactive and iterative procedure may be repeated as needed to develop a cryoablation plan that achieves the ice ball formation boundaries 50 desired by the clinician.

When the results of the simulation are satisfactory, the clinician may begin placing in cryoprobes having properties substantially similar to those of virtual cryoprobes 32 into the tumor T or other tissue to be ablated. When some or all of the cryoprobes have been positioned, a scan and image processing may be conducted by image generator 18 and provided to the processor 14. This new scan may be brought into spatial alignment with the pre-procedure planning image(s) (e.g., using image registration) to assure that the position of the cryoprobes in the actual tumor match the position of the virtual cryoprobes 32 on the planning image.

The user interface 30 also provides facilities for comparing images acquired during the actual cryoablation procedure with those acquired during the simulation. The system 10 may acquire images at regular intervals during the procedure, display them on the user interface 30, and compare the intra-procedure images with the pre-procedure planning images. For example, a freeze-thaw-freeze cycle may consist of a ten minute freeze cycle, a ten minute thaw cycle, and a ten minute freeze cycle. The system 10 may acquire images after the first ten minute freeze cycle for comparison with the simulated procedure after the first ten minute freeze cycle. This enables the clinician to monitor the progress of the procedure, to validate the outcome of the procedure, and to compare the simulation to actual ice ball formation.

To illustrate, FIG. 5 is a partial screen shot of user interface 30 showing an intra-procedure image after a portion of a cryoablation procedure is performed. The user interface 30 may be used to measure characteristics of the boundaries 50 to aid in determining validate the progress of the ice ball formation. For example, the user interface 30 may include the capability to determine manual and/or computer-assisted delineation of lesion boundaries for comparison of lethal ice volume to lesion volume (including safety margins about the lesion), time course of heat change at a given region of the image, and volume rate of change of ice ball formation and lethal ice.

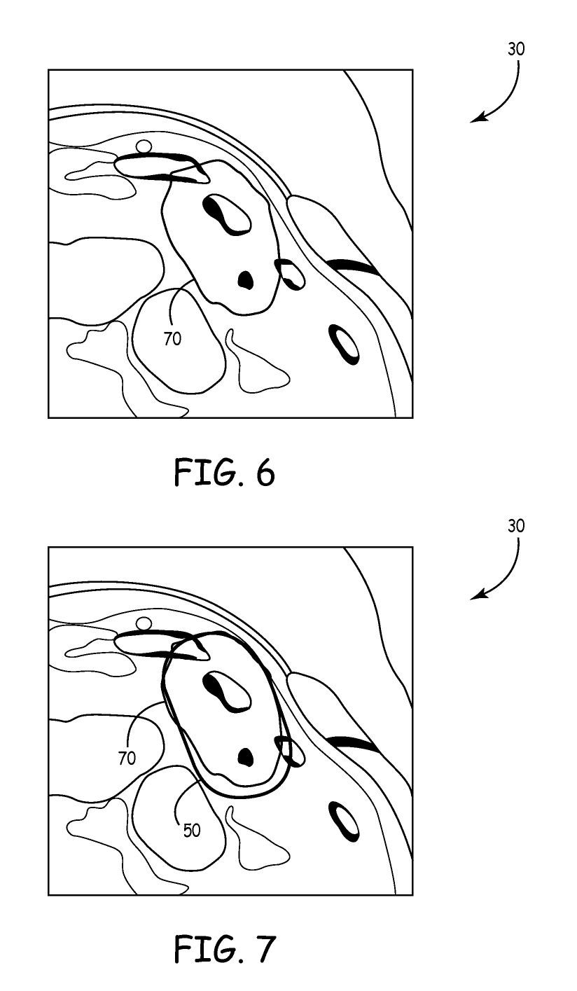

The user interface 30 may also be used to enlarge selected portions of the intra-procedure image for a more detailed analysis. For example, a selection box 60 as shown in FIG. 5 may be used to select the portion of the image that includes the tissue on which cryosurgery is being performed. FIG. 6 is a partial screen shot of user interface 30 showing an enlarged view of the portion of the anatomy highlighted by the selection box 60 in FIG. 5.

The user interface 30 may provide tools to trace the contours of the actual ice ball formation. For example, an experienced radiologist or other clinician may use the tools provided on the user interface 30 to trace the boundaries 70 of the actual ice ball formation. Alternatively, the user interface 30 and the processor 14 may include the ability to automatically trace the boundaries 70 of the actual ice ball formation based on the different response of the affected tissue in the intra-procedure image compared to normal tissue. The boundaries 70 of the actual ice ball formation may be used to validate that the actual ice ball formation is progressing as expected, and to monitor the progress of the procedure.

The user interface 30 may also be used to compare the boundaries 70 of the actual ice ball formation to the boundaries 50 of the simulated ice ball formation. FIG. 7 is a partial screen shot of a portion of the intra-procedure image showing the simulated ice ball boundaries 50 from FIG. 5 overlayed with the actual ice ball boundaries 70. Various algorithms may be used to compare the boundaries 50 and 70. For example, the processor may determine a Dice Similarity Coefficient (DSC), which ranges from zero to one and is a measure of volume overlap, mean absolute difference (MAD), which is the mean of the absolute distances from each point in boundary 50 to the nearest boundary point in the boundary 70, mean signed distance (MSD) which calculates the mean of the signed distances, or the Hausdorff distance, which finds the largest distance between the boundaries 50 and 70. For thicker groups of slices, each measurement may be calculated in two-dimensions on each slice.

In summary, the present invention relates to a system and method for planning and simulating a cryoablation procedure at a surgery site. One or more pre-procedure planning images of the surgery site are displayed on a user interface. Positioning of one or more virtual cryoprobes relative to the one or more pre-procedure planning images on the user interface is facilitated. Properties of the one or more virtual cryoprobes are selectable. Ice ball formation at the surgery site is then simulated based on the position and properties of the virtual cryoprobes. The simulated ice ball formation is based at least in part on tissue properties of the surgery site at each image unit of the one or more pre-procedure planning images. Boundaries of the simulated ice ball formation on the one or more pre-procedure planning images are then displayed. By basing the simulation on tissue properties of each image unit (i.e., pixel, voxel, etc.) in the planning images, the boundaries of the simulated ice ball formation at the surgery site are accurately defined and displayed. If necessary, the surgeon can then reposition the locations of the virtual cryoprobes and on the planning images and re-simulate the ice ball formation. This iterative approach to the planning of the cryoablation procedure allows the surgeon to optimize the locations of the cryoprobes prior to the actual surgery. The ability to acquire images of the surgery site during the procedure allows the surgeon to evaluate and validate the cryoablation plan and, if necessary, update the locations of the cryoprobes.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A system for planning and simulating a cryoablation procedure at a surgery site, the system comprising:
a display including a user interface configured to display one or more pre-procedure planning images of the surgery site;
an input device operable to position one or more virtual cryoprobes relative to the one or more pre-procedure planning images on the user interface and to select properties of the one or more virtual cryoprobes; and
a processor configured to simulate ice ball formation at the surgery site based on the positions and properties of the one or more virtual cryoprobes, wherein the simulated ice ball formation is based at least in part on tissue properties of the surgery site at each image unit of the one or more pre-procedure planning images, and to cause boundaries of the simulated ice ball formation to be displayed on the one or more pre-procedure planning images.

2. The system of claim 1, wherein the input device is further operable to reposition the one or more virtual cryoprobes relative to the one or more pre-procedure planning images after the simulated ice ball formation, and wherein the processor is further configured to re-simulate the ice ball formation at the surgery site based on repositioned one or more virtual cryoprobes.

3. The system of claim 1, wherein the one or more pre-procedure planning images comprise one or more two-dimensional images.

4. The system of claim 3, wherein the one or more virtual cryoprobes are each positionable at an oblique angle relative to the one or more two-dimensional images.

5. The system of claim 3, wherein the user interface is configured to adapt positions of the one or more virtual cryoprobes on one of the one or more two dimensional images to others of the one or more two dimensional images.

6. The system of claim 1, wherein the user interface is further configured to display one or more intra-procedure images acquired during the cryoablation procedure, wherein the intra-procedure images include boundaries of an actual ice ball formation of the cryoablation procedure.

7. The system of claim 6, wherein the user interface is configured to overlay the boundaries of the simulated ice ball formation and boundaries of the actual ice ball formation on the one or more intra-procedure images.

8. The system of claim 6, wherein the one or more intra-procedure images are acquired at multiple points during the cryoablation procedure.

9. The system of claim 1, wherein the properties of each of the one or more virtual cryoprobes are adjustable during the simulation.

10. The system of claim 9, wherein the properties are adjusted to simulate a freeze-thaw-freeze cycle at the surgery site.

11. A method for planning and simulating a cryoablation procedure at a surgery site, the method comprising:
displaying one or more pre-procedure planning images of the surgery site on a user interface;
receiving inputs that position one or more virtual cryoprobes relative to the one or more pre-procedure planning images on the user interface;
receiving inputs that select properties of the one or more virtual cryoprobes;
simulating ice ball formation at the surgery site based on the position and properties of the virtual cryoprobes, wherein the simulated ice ball formation is based at least in part on tissue properties of the surgery site at each image unit of the one or more pre-procedure planning images; and
displaying boundaries of the simulated ice ball formation on the one or more pre-procedure planning images.

12. The method of claim 11, and further comprising:
facilitating repositioning of the one or more virtual cryoprobes relative to the one or more pre-procedure planning images after the simulated ice ball formation; and
re-simulating the ice ball formation at the surgery site based on repositioned one or more virtual cryoprobes.

13. The method of claim 11, wherein the one or more pre-procedure planning images comprise one or more two-dimensional images.

14. The method of claim 13, wherein the one or more virtual cryoprobes are positionable at an oblique angle relative to the one or more two-dimensional images.

15. The method of claim 13, and further comprising:
adapting positions of the one or more virtual cryoprobes on one of the one or more two dimensional images to others of the one or more two dimensional images.

16. The method of claim 11, and further comprising:
displaying one or more intra-procedure images acquired during the cryoablation procedure on the user interface, wherein the intra-procedure images include boundaries of an actual ice ball formation of the cryoablation procedure.

17. The method of claim 16, and further comprising:
overlaying the boundaries of the simulated ice ball formation and the boundaries of the actual ice ball formation on the one or more intra-procedure images.

18. The method of claim 16, wherein the one or more intra-procedure images are acquired at multiple points during the cryoablation procedure.

19. The method of claim 11, wherein the properties of each of the one or more virtual cryoprobes are adjustable during the simulation.

20. The method of claim 19, wherein the properties are adjusted to simulate a freeze-thaw-freeze cycle at the surgery site.

21. A method for planning and simulating a cryoablation procedure at a surgery site, the method comprising:
acquiring images of the surgery site;
displaying one or more two-dimensional pre-procedure planning images of the surgery site based on the acquired images;
facilitating positioning of one or more virtual cryoprobes relative to the one or more pre-procedure planning images, wherein the virtual cryoprobes are positionable at an oblique angle relative to the one or more two-dimensional images;
simulating ice ball formation at the surgery site based on the position and properties of the one or more virtual cryoprobes; and
displaying boundaries of the simulated ice ball formation on the one or more pre-procedure planning images.

22. The method of claim 21, and further comprising:
acquiring intra-procedure images of the surgery site during the cryoablation procedure; and
displaying one or more intra-procedure images including boundaries of an actual ice ball formation of the cryoablation procedure.

23. The method of claim 22, and further comprising:
overlaying the boundaries of the simulated ice ball formation and the boundaries of the actual ice ball formation on the one or more intra-procedure images.

24. The method of claim 21, wherein the simulated ice ball formation is based at least in part on tissue properties of the surgery site at each image unit of the one or more pre-procedure planning images.
